(19) United States
(12) Patent Application Publication
(10) Pub. No.: US 2004/0100504 A1
(43) Pub. Date: May 27, 2004

(54) Item selection systems and methods of displaying the same

(76) Inventor: Jored Sommer, Redwood City, CA (US)

Correspondence Address: BAKER & BOTTS, 30 ROCKEFELLER PLAZA, NEW YORK, NY, 10112

(21) Appl. No.: 10/444,694

(22) Filed: May 23, 2003

Related U.S. Application Data
(60) Provisional application No. 60/382,587, filed on May 24, 2002.

(51) Int. Cl. G09G 5/00

(52) U.S. Cl. 345/810

(57) ABSTRACT

An item selection system includes a first menu projected in a first menu space of a viewing surface. The first menu has a first plurality of items and a cursor adapted for movement amongst the first plurality of items and for selecting a particular item from the first plurality of items. The selection system also includes a second menu projected in a second menu space of the viewing surface, such that the first menu and the second menu are simultaneously displayed in the viewing surface. Specifically, the second menu space is positioned adjacent to the first menu space. Moreover, the second menu has a second plurality of items associated with the particular item, such that when the cursor selects the particular item, the second menu replaces the first menu in the first menu space. In an embodiment, when the cursor selects the particular item, a third menu replaces the second menu in the second menu space. Specifically, the third menu has a third plurality of items, and the third plurality of items are associated with one of the second plurality of items.

### CROSS-REFERENCE TO RELATED APPLICATION

This application claims priority from U.S. Provisional Patent Application No. 60/382,587, entitled “Menu Systems and Methods of Using the Same,” and filed on May 24, 2002, the disclosure of which is incorporated herein by reference in its entirety.

### FIELD OF THE INVENTION

The present invention relates generally to item selection systems and display techniques, and in particular, to such techniques in which a first menu is positioned in a first menu space, a second menu is positioned in a second menu space, a cursor is used to select a particular item from the first menu, and the second menu then replaces the first menu.

### BACKGROUND OF THE INVENTION

Item selection systems are often used in hotel video on-demand systems to provide a hotel guest with an user-friendly interface for selecting movies and other audio-visual products. In known item selection systems, a first menu is displayed on a television screen. The first menu has a first plurality of items from which a user of the system selects. For example, a first item of the first menu may correspond to “movies,” and a second item of the first menu may correspond to “games.”

When the user selects the item corresponding to “movies,” a second menu replaces the first menu. The second menu has a second plurality of items from which the user selects. For example, a first item of the second item may correspond to “action movies,” and a second item of the second menu may correspond to “comedy movies.”

When the user selects the item corresponding to “action movies,” a third menu replaces the second menu. The third menu has a third plurality of items, and each of the third plurality of items corresponds to a movie which is available for the user to view. When the user selects the item corresponding to a particular movie, the user is prompted to confirm their purchase. After the user confirms their purchase, the user can watch the particular movie on the television.

Nevertheless, prior to selecting a particular item in a particular menu, the user is not able to determine the further items which will be available to the user after the user selects the particular item. For example, prior to selecting the item corresponding to “action movies,” the user does not know which action movies will be available to the user. As such, the user does not know the consequence of selecting the particular item, and the user relies on the descriptiveness of the title associated with the particular item to predict the consequence of selecting the particular item. Moreover, when the selection system is used in a hotel, a motel, or the like, the user likely is not familiar with the selection system, which increases the difficulty of using such known systems. Therefore, a need has arisen for an item selection system and a method of displaying the same which overcome these and other shortcomings of the related art.

### SUMMARY OF THE INVENTION

An object of the present invention is to allow the user of the-item selection system to understand the consequences of selecting the particular item before the user selects the particular item. Another object of the present invention is to provide an item selection system for use in a hotel video on-demand system which provides a hotel guest with an user-friendly interface for selecting movies and other audio-visual products. In order to meet these objectives and others that will become apparent with reference to the disclosure below, the present invention provides an item selection system in which a first menu is positioned in a first menu space, a second menu is positioned in a second menu space, and when a cursor selects a particular item from the first menu, the second menu replaces the first menu.

Preferably, the second menu has items which are associated with the particular item. As a user of the system can view both the first menu and the second menu before selecting the particular item, the user can view those items which will be available to the user after the user selects the particular item.

Advantageously, a user may move the cursor up and/or down within the first menu space, and each item in the first menu may have at least one associated item. When the cursor moves from the particular item to a further item within the first menu, the second menu changes e.g., to a third menu, to display items which are associated with the further item. When the user selects the further item, the third menu replaces the first menu.

According to a preferred embodiment of the present invention, an item selection system includes a first menu projected in a first menu space of a viewing surface. The first menu has at least one first item, and a cursor adapted for movement among the at least one first item and for selecting a particular item from the at least one first item. The item selection system also has a second menu projected in a second menu space of the viewing surface, such that the first menu and the second menu are simultaneously projected in the viewing surface. The second menu space is positioned adjacent to the first menu space. Moreover, the second menu has at least one second item associated with the particular item, such that when the cursor selects the particular item, at least one portion of the second menu replaces the first menu.

In another embodiment, the at least one first and second items are a first plurality of items and a second plurality of items, respectively, and when the cursor selects the particular item, a third menu replaces the second menu. Specifically, the third menu has a third plurality of items, and the third plurality of items are associated with one of the second plurality of items.

According to another preferred embodiment of the present invention, a method for displaying an item selection system is provided, and includes projecting a first menu in a first menu space of a viewing surface. The first menu has a first plurality of items, and a cursor adapted for moving among the first plurality of items and for selecting a particular item from the first plurality of items. The method also includes simultaneously projecting a second menu in a second menu space of the viewing surface. The second menu space is positioned adjacent to the first menu space. The second menu has a second plurality of items associated with the particular item, such that when the cursor selects the particular item, at least one portion of the second menu replaces the first menu.

Other objects, features, and advantages will be apparent to persons of ordinary skill in the art from the following detailed description of the invention and the accompanying drawings.

### BRIEF DESCRIPTION OF THE DRAWINGS

For a more complete understanding of the present invention, the needs satisfied thereby, and the objects, features, and advantages thereof, reference now is made to the following description taken in connection with the accompanying drawings.

FIG. 1 is a schematic diagram of an item selection system including a first menu and a second menu displayed simultaneously according to an embodiment of the present invention.

FIG. 2 is a block diagram depicting a three-level hierarchy scheme of an item selection system according to an embodiment of the present invention.

FIG. 3 is a block diagram depicting a three-level hierarchy scheme of an item selection system according to another embodiment of the present invention.

FIG. 4 is a block diagram depicting a three-level hierarchy scheme of an item selection system according to yet another embodiment of the present invention.

FIG. 5 is an exemplary schematic diagram of a controller for moving a cursor of the item selection system of FIG. 1.

FIGS. 6a-6e are exemplary schematic diagrams of the cursor of the item selection system of FIG. 1.

FIG. 7 is a schematic diagram of the item selection system of FIG. 1, after the second menu replaces the first menu and a third menu replaces the second menu.

FIG. 8 is a schematic diagram of the item selection system of FIG. 7, in which a user of the system has scrolled to the bottom of the second menu.

FIG. 9 is a schematic diagram of the item selection system of FIG. 1, in which a word or a phrase corresponding to a particular item of the first menu has been replaced by an image corresponding to the particular item.

FIG. 10 is a schematic diagram of the item selection system of FIG. 1, in which when the cursor is positioned on an item in the first menu, a word or a phrase corresponding to the item is replaced by an image corresponding to the item.

FIG. 11 is a schematic diagram of the item selection system of FIG. 1, depicting an exemplary final stage in the hierarchy of the item selection system.

FIGS. 12a-12c are flow diagrams depicting a first stage, a second stage, and a third stage, respectively, of an operation of the item selection system of FIG. 1 according to an exemplary embodiment of the present invention.

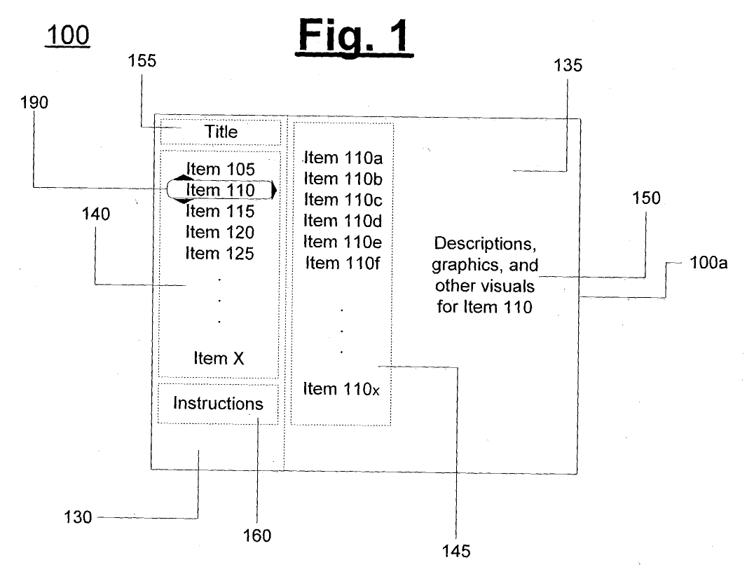

In FIGS. 1-12c, like numerals are used for like corresponding parts in the various drawings.

### DETAILED DESCRIPTION OF PREFERRED EMBODIMENTS

Referring to FIG. 1, an item selection system 100 according to an embodiment of the present invention is depicted. Item selection system 100 may be displayed on a viewing surface 100a, such as a television screen, a computer screen, or the like. In an exemplary embodiment, item selection system 100 may be used in a hotel, a motel, or the like. Item selection system 100 may include a first menu 140 projected in a first menu space 130, and a second menu 145 projected in a second menu space 135, such that a user of item selection system 100 may simultaneously view first menu 140 and second menu 145. First menu space 130 may include a title space 155 for displaying a name of the menu currently projected in first menu space 130, and an instruction space 160 for displaying instructions associated with the menu currently projected in first menu space 130. First menu 140 may include at least one item, such as items 105-125. For example, item 105 may correspond to “internet,” item 110 may correspond to “games,” item 115 may correspond to “movies,” item 120 may correspond to “local information,” and item 125 may correspond to “hotel information and/or services.” Nevertheless, it will readily be understood by those of ordinary skill in the art that first menu 140 may include any number of items, and that the last item in first menu 140 may be designated as “item X,” where “X” is the total number of items in first menu 140.

First menu 140 also may include a cursor 190, such as a hotspot indicator, for selecting one of the items in first menu 140, such as items 105-125. In the present invention, a cursor is defined as any indicator, such as a visual indicator, showing or otherwise indicating the user's current location or position within selection system 100.

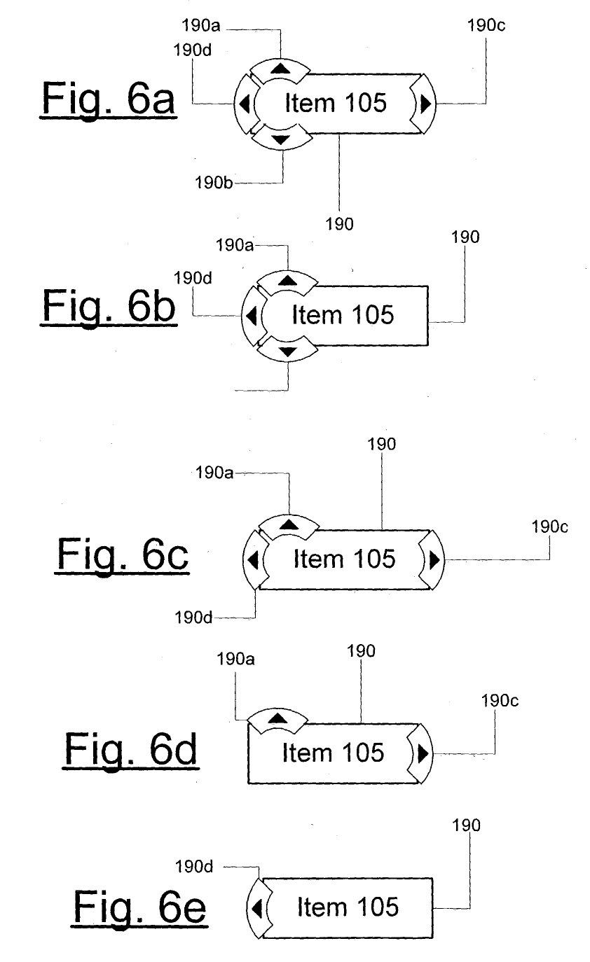

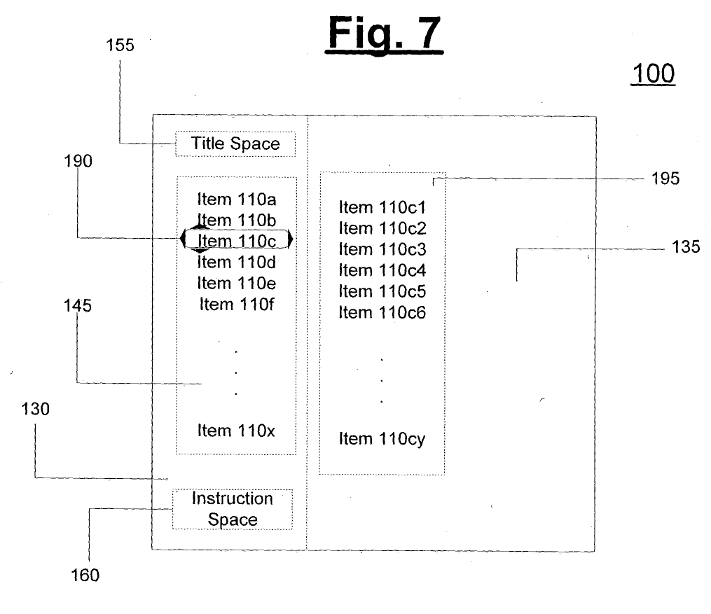

Referring to FIGS. 6a-6e, cursor 190 may include an indicator for indicating at least one navigation option for the user. For example, the indicator may include at least one directional arrow, such as directional arrows 190a-190d, which indicate whether it is possible for the user to move cursor 190 in a predetermined direction, such as in an up direction, a down direction, a left direction, or a right direction.

Second menu 145 may include at least one item associated with one of the items in first menu 140. Specifically, cursor 190 may be positioned adjacent to or may surround a particular one of the items in first menu 140, and the items listed in second menu 145 may be associated with this particular item. The item which cursor 190 is positioned adjacent to or surrounds is hereinafter referred to as the “focus item.”

Referring to FIG. 1, when item 110 is the “focus item,” second menu 145 may include items 110a-100f, and items 110a-110f may be associated with item 110. For example, when item 110 corresponds to “games,” each of items 110a-110f may correspond to a different type of gaming system. For example, item 110a may correspond to “Playstation® II,” manufactured by Sony Computer Entertainment Inc., which has a principle place of business in San Mateo, Calif., “Nintendo® 64,” manufactured by Nintendo of America, Inc., which has a principle place of business in Redmond, Wash., or the like. Nevertheless, it will readily be understood by those of ordinary skill in the art that second menu 145 may include any number of items, and that the last item in second menu 145 may be designated as “item Ax,” where “A” is the reference numeral associated with the “focus item” in first menu 140, and “x” is the total number of items in second menu 145.

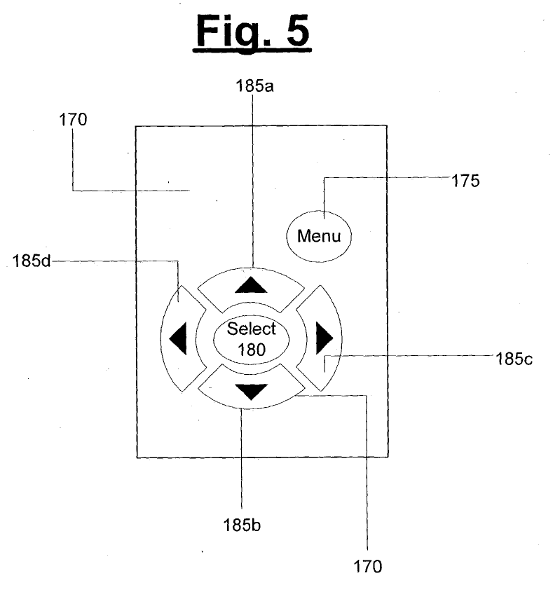

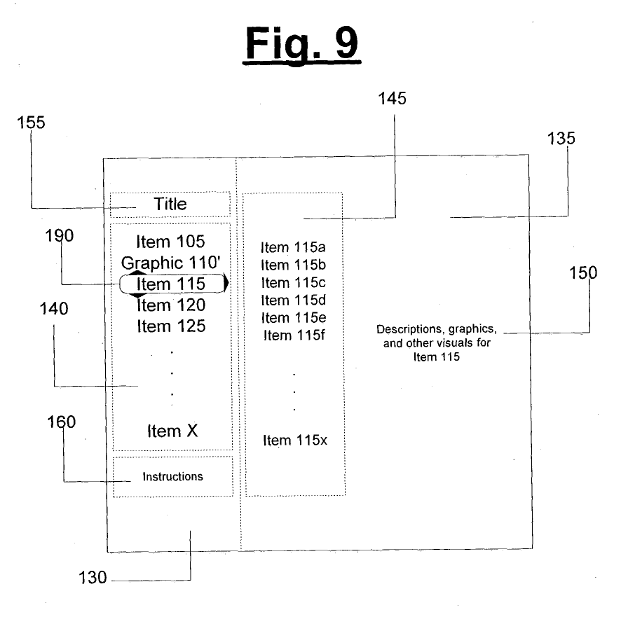

Referring to FIGS. 5 and 9, item selection system 100 also may include a device for moving cursor 190 within first menu space 130. For example, the device for moving cursor 190 may be a mouse (not shown), a controller 170, such as a remote controller, comprising at least one directional button, such as directional buttons 185a-185d, or the like. When cursor 190 moves from item 110 to item 115, such that item 115 becomes the “focus item,” the items listed in second menu 145 may change from items 110a-110f to items 115a-115f.

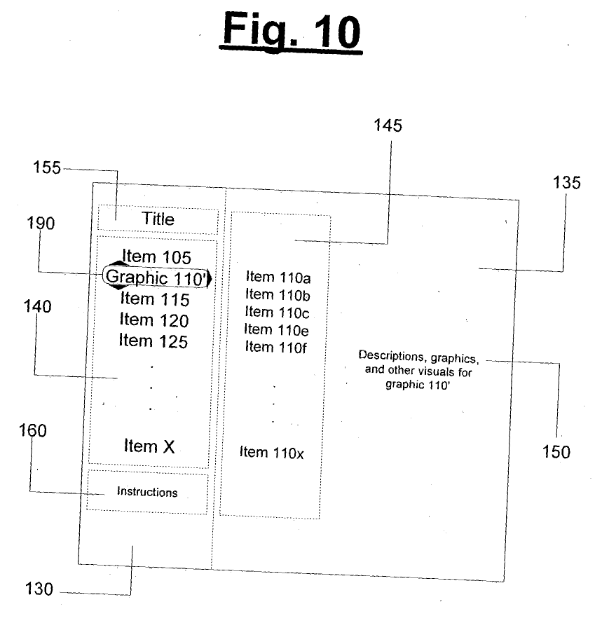

For example, when item 115 corresponds to “movies,” each of items 115a-115f may correspond to a type of movie, such as “action movies,” “comedy movies,” “drama movies,” or the like. In another embodiment, when item 115 corresponds to “movies,” and there are not several types of movies available for viewing, each of items 115a-115f may correspond to a particular movie which is available for viewing. In another embodiment, second menu space 135 also may include at least one graphic 150, such as an image, a word/phrase, a video, or a combination thereof, associated with the “focus item” or associated with one of the items in second menu 145. Moreover, as shown in FIG. 9, the items in first menu 140 and/or the items in second menu 145 may be a word/phrase, an image, or a combination thereof. For example, in FIG. 9, items 105, 115, 120, and 125 are a word/phrase, and item 110 is replaced by an item 110 which is an image. Referring to FIG. 10, in another embodiment, the “focus item” may be an image, and the remaining items may be a word/phrase.

Referring to FIGS. 1 and 7, during operation, the user may move cursor 190 via the device for moving cursor 190, such that an item in first menu 140, which the user wishes to further investigate, is the “focus item.” The user then may activate cursor 190, such as by applying pressure to a select button 180 of controller 170, such that cursor 190 selects the “focus item” in first menu 140. When cursor 190 selects the “focus item” in first menu 140, at least a portion of second menu 145 may replace first menu 140. First menu space 130 may be regenerated, second menu 145 may physically move from second menu space 135 to first menu space 130, or the like.

For example, in FIG. 1, item 110 is the “focus item,” and items 110a-110f are included in second menu 145. As shown in FIG. 7, when cursor 190 selects item 110, second menu 145 may replace first menu 140, such that second menu 145 and items 110a-110f now are projected in first menu space 130. In an embodiment, a portion of second menu 145 may replace first menu 140, or the entire second menu 145 may replace first menu 140.

In another embodiment, second menu 145 may not include all of the items which are associated with the “focus item” in first menu 140. In this embodiment, when cursor 190 selects the “focus item” in first menu 140, the entire second menu 145 and those items which originally were missing from second menu 145 may replace first menu 140.

In another embodiment of the present invention, when cursor 190 selects the “focus item” in first menu 140, in addition to second menu 145 replacing first menu 140, a third menu 195 may replace second menu 145. Third menu 195 may include at least one item associated with one of the items in second menu 140. Specifically, when second menu 145 replaces first menu 140, a predetermined one of the items in second menu 145 becomes the “focus item.” When item 110c is the “focus item,” third menu 195 may include items 110c1-110c6, and items 110c1-110c6 may be associated with item 110c. For example, when item 110c corresponds to a “Playstation® II” gaming system, each of items 110c1-110c6 may correspond to a different Playstation® II game. For example, item 110c1 may correspond to “Tony Hawk's Pro Skater®4,” manufactured by Activision, Inc. which has a principle place of business in Santa Monica, Calif., “Cabela's® Big Game Hunter®,” manufactured by Activision, Inc., or any other game which may be played using a Playstation® II. Nevertheless, it will readily be understood by those of ordinary skill in the art that third menu 195 may include any number of items, and that the last item in third menu 195 may be designated as “item Ay,” where “A” is the reference numeral associated with the “focus item” in second menu 145, and “y” is the total number of items in third menu 195.

In an embodiment, at least one of the items in second menu 145 may not have an associated third menu 195, such that when this item is the “focus item,” second menu space 135 may be empty or just may include graphic 150. However, if cursor 190 subsequently moves from the item in second menu 145 which does not have an associated third menu 195 to an item in second menu 145 which has an associated third menu 195, the associated third menu 195 appears in second menu space 135 after the movement of cursor 190 occurs.

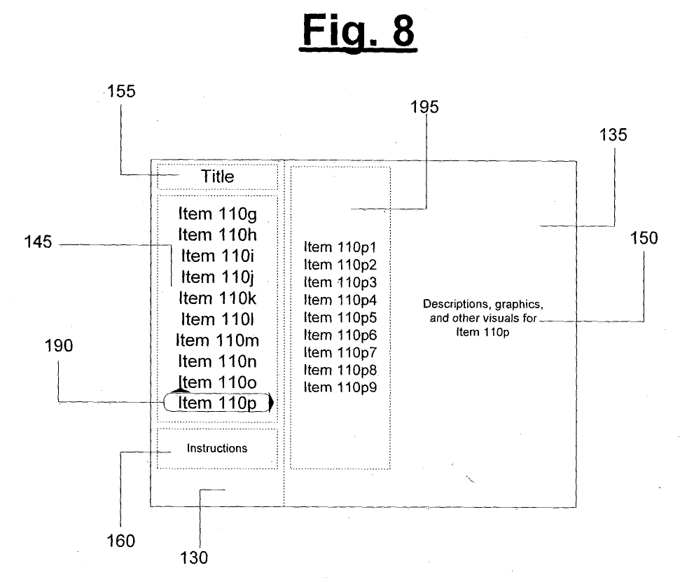

Moreover, the size of first menu space 130 may be such that not all of the items included in first menu space 130 may be simultaneously viewed by the user. As shown in FIG. 8, the user can use the device for moving cursor 190 to scroll through the menu, such as to scroll through second menu 145. For example, second menu 145 may include items 110a-110p, and when cursor 190 is at the bottom of second menu 145, items 110g-110p may be viewable, but items 110a-110f may not be viewable. In this embodiment, when item 110p is the “focus item” of second menu 145, third menu 195 may include items 110p1-110p9.

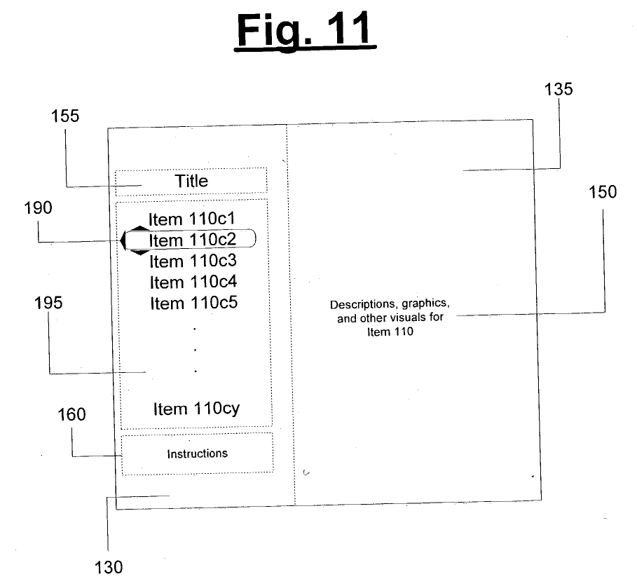

Referring to FIGS. 7 and 11, after second menu 145 replaces first menu 140, and third menu 195 replaces second menu 145, the user again may activate cursor 190, such that cursor 190 selects the “focus item” in second menu 145. When cursor 190 selects the “focus item” in second menu 145, at least a portion of third menu 195 may replace second menu 145. First menu space 130 may be regenerated, third menu 195 may physically move from second menu space 135 to first menu space 130, or the like. For example, in FIG. 7, item 110c is the “focus item,” and items 110c1-110c6 are included in third menu 195.

As shown in FIG. 11, when cursor 190 selects item 110c, third menu 195 may replace second menu 145, such that third menu 195 and items 110c1-110c6 now are projected in first menu space 130. In an embodiment, a portion of third menu 195 may replace second menu 145, or the entire third menu 195 may replace second menu 145. In another embodiment, third menu 195 may not include all of the items which are associated with the “focus item” in second menu 145. In this embodiment, when cursor 190 selects the “focus item” in second menu 145, the entire third menu 195 and those items which originally were missing from third menu 195 may replace second menu 195.

Referring again to FIG. 11, when third menu 195 replaces second menu 145, and third menu 195 is the last menu in a hierarchy scheme of item selection system 100, second menu space 135 may not include a menu. Specifically, in this embodiment, when cursor 190 selects one of the items in third menu 195, the selection process is complete, and the user will be able to view the selected movie, play the selected game, or the like. Nevertheless, when third menu 195 replaces second menu 145, and third menu 195 is not the last menu in the hierarchy scheme of item selection system 100, a fourth menu (not shown) may replace third menu 195 within second menu space 135. It will readily be understood by those of ordinary skill in the art that this replacement process may continue until the last menu available to the user is positioned in first menu space 130.

Moreover, item selection system 100 may incorporate some of the features of the known item selection systems. In this embodiment, when first menu 140 is positioned within first menu space 130, second menu 145 may not be viewable. For example, second menu 145 may not be positioned within second menu space 135. Nevertheless, after the “focus item” of first menu 140 is selected, second menu 145 may replace first menu 140, and third menu 195 may be positioned within second menu space 135, such that the user can simultaneously view second menu 145 and third menu 195.

In another embodiment, after second menu 145 replaces first menu 140, the user of item selection system 100 subsequently may return to first menu 140, such as by applying pressure to directional button 185d of controller 170. When the user applies pressure to directional button 185d, first menu 140 may replace second menu 145 in first menu space 130. Moreover, second menu 145 may replace third menu 195 in second menu space 140. Similarly, after third menu 195 replaces second menu 145 in first menu space 130, the user of item selection system 100 subsequently may return to first menu 140, such as by applying pressure to directional button 185d of controller 170. When the user applies pressure to directional button 185d, second menu 145 may replace third menu 195 in first menu space 130. Moreover, third menu 195 may replace the fourth menu (if there is a fourth menu) in second menu space 140.

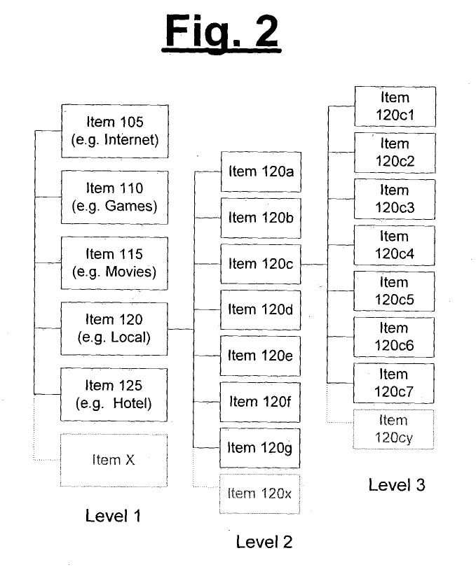

Referring to FIG. 2, a block diagram of an exemplary three-level hierarchy scheme of item selection system 100 is depicted. The number of levels in the hierarchy scheme of item selection system 100 may correspond to the number of menus which are available to the user. In this example, item 120 is the “focus item” of first menu 140, and second menu 145 includes items 120a-120g which are associated with item 120. In this embodiment, after second menu 145 replaces first menu 140 and third menu 195 replaces second menu 145, item 120c becomes the “focus item” of second menu 145. Moreover, third menu 195 includes items 120c1-120c7.

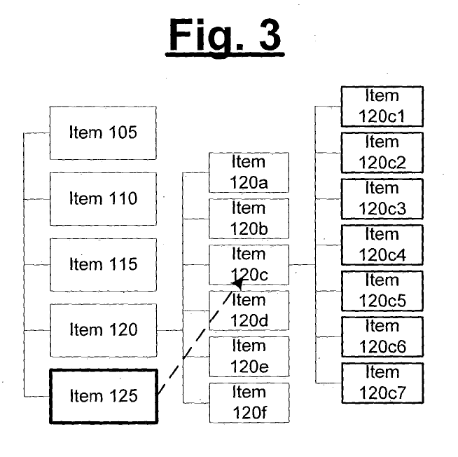

Referring to FIG. 3, the hierarchy scheme of FIG. 2 may be modified to account for programing redundancies. In this embodiment, when item 120 is the “focus item” in first menu 140, second menu 145 may include at least item 120c, and when item 125 is the “focus item” in first menu 140, second menu 145 also may include at least item 120c, such that item 120c is associated with both item 120 and item 125. For example, a particular movie may be both a “drama movie” and an “action move.” To reduce the programming redundancies, there may be a single item 120c which is common to item 120 and item 125. For example, when item 120 is the “focus item” in first menu 140, item selection system 100 may follow the hierarchy scheme set forth in FIG. 2. Nevertheless, when item 125 is the “focus item” in first menu 140, item selection system 100 may jump from item 125 to the hierarchy scheme of item 120 to display item 120c. As such, programming redundancies may be reduced. It will be understood by those of ordinary skill in the art that the hierarchy scheme of FIG. 3 may be applied whenever an item is associated with several other items.

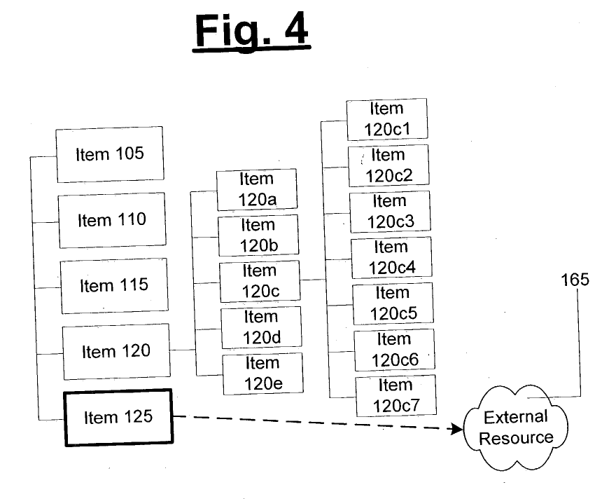

Referring to FIG. 4, in another exemplary hierarchy scheme, selecting one of the items in one of the menus may allow the user to access an external resource 165, such as a program, a device, or the like, which is not part of a current item selection session. The user then may return to their current item selection session by activating a return link, e.g., by applying pressure to a predetermined button of controller 170, such as a menu button 175 or a left arrow button 185d.

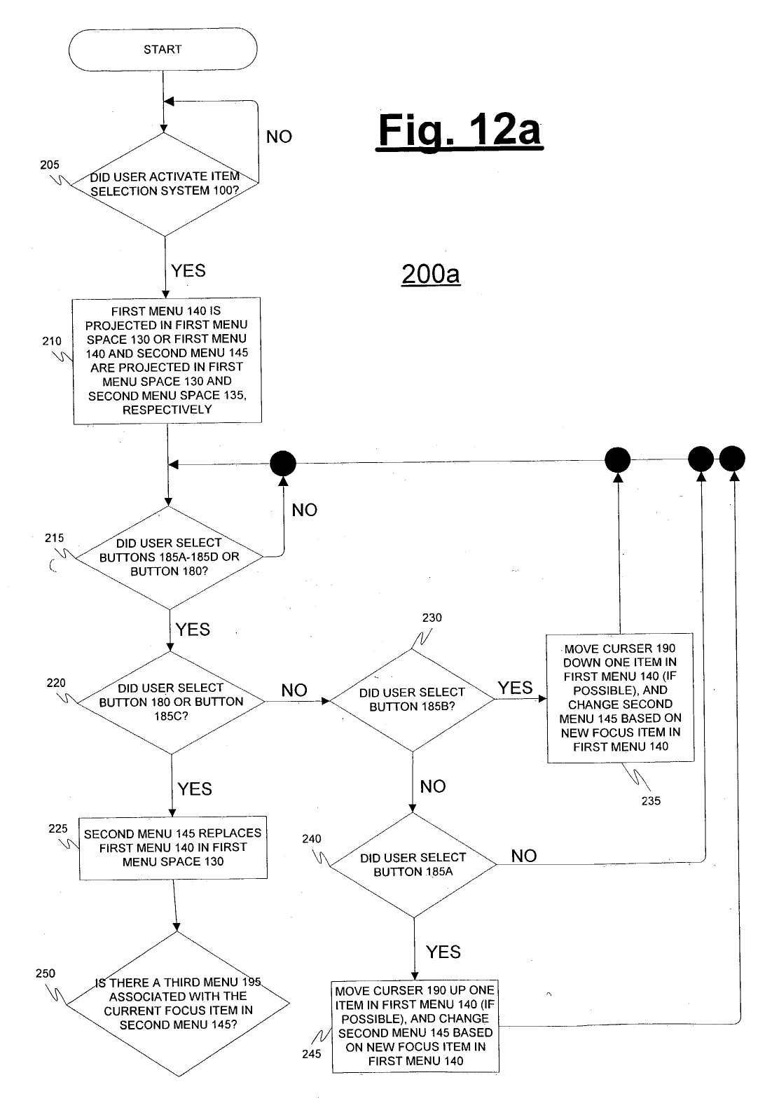

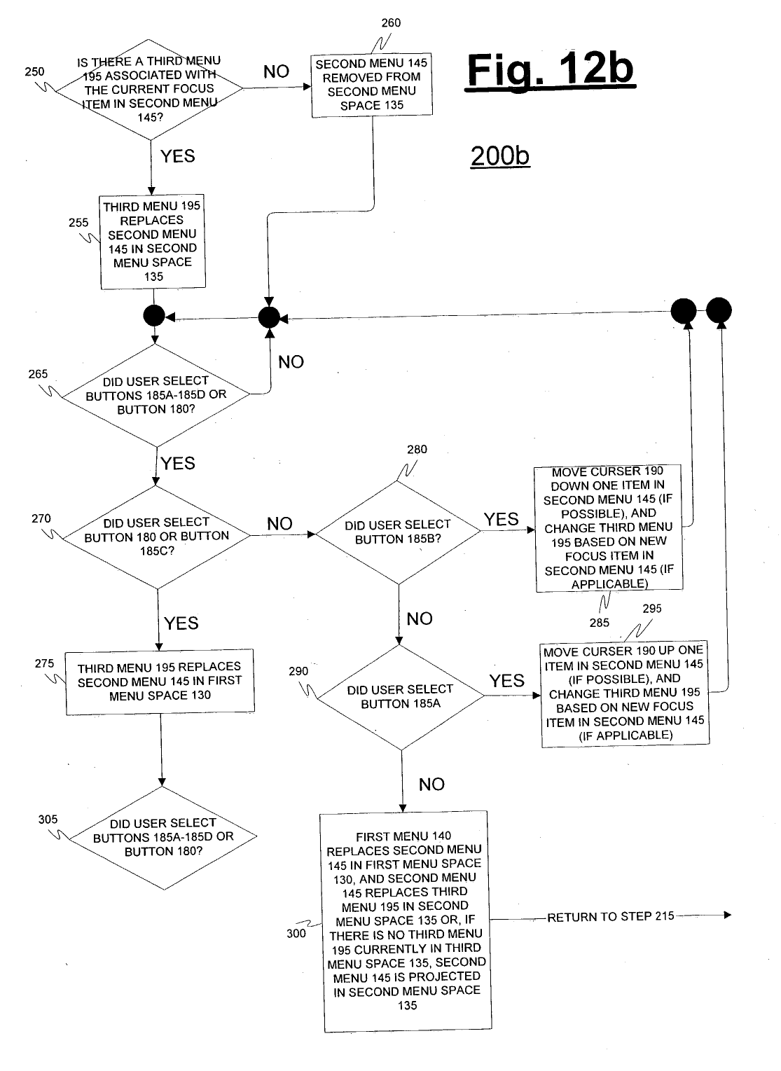

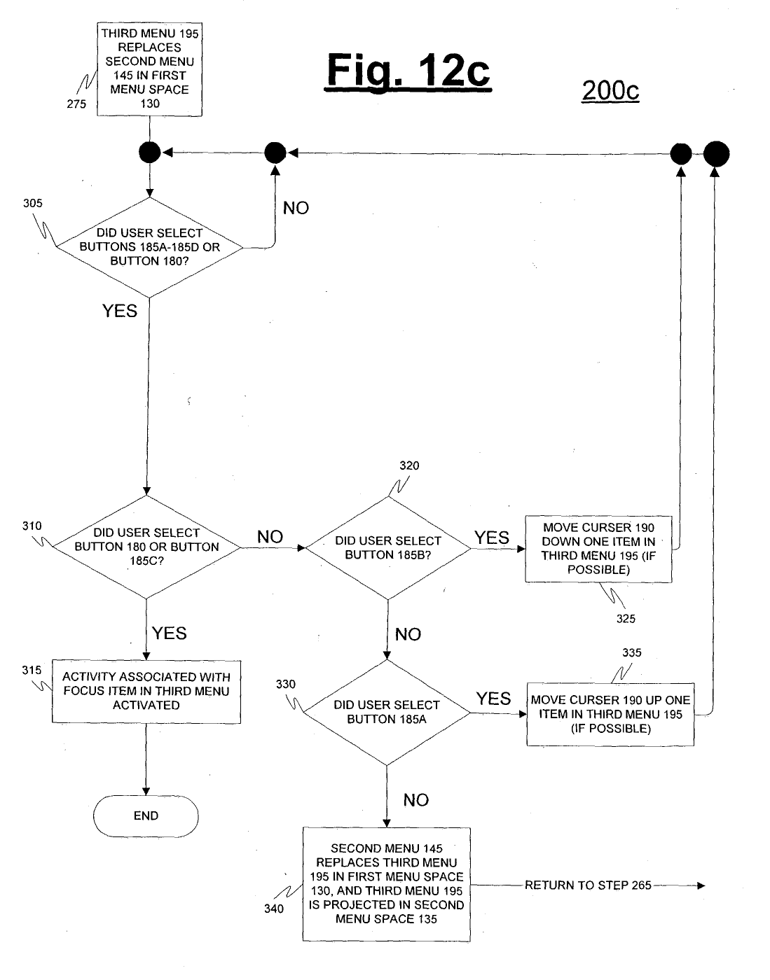

Referring to FIGS. 12a-12c, a preferred embodiment of an operation 200 of item selection system 100 is depicted. Specifically, FIG. 12a depicts a first stage 200a of operation 200 of item selection system 100, FIG. 12b depicts a second stage 200b of operation 200 of item selection system 100, and FIG. 12c depicts a third stage 200c of operation 200 of item selection system 100. As such, in this embodiment, third menu 195 is the last menu in the hierarchy of item selection system 100. Moreover, in this embodiment, controller 170 is used to move cursor 190, and buttons 180 and 185a-185d have a predetermined function. Nevertheless, it will be readily understood by those of ordinary skill in the art that item selection system 100 can have any number of stages, and that other devices may be used to move cursor 190. Moreover, the operation of item selection system 100 readily may be modified to encompass any of the above-described embodiments of the present invention, and that this embodiment is merely exemplary.

Referring to FIG. 12a, in step 205, item selection system 100 may determine whether the user activated selection system 100. When the user activates selection system 100, in step 210, item selection system 100 projects first menu 140 in first menu space 130. In an embodiment, in step 210, item selection system 100 also projects second menu 145 in second menu space 135. In step 215, item selection system 100 determines whether the user selected button 180 or one of buttons 185a-185d. If the user did not select button 180 or one of buttons 185a-185d, operation 200 returns to step 215 until the user selects button 180 or one of buttons 185a-185d. After the user selects button 180 or one of buttons 185a-185d, in step 220, item selection system 100 determines whether the selected button is button 180 or button 185c. If the selected button is button 180 or button 185c, then in step 225, item selection system 100 replaces first menu 140 with second menu 145 in first menu space 130.

However, if the selected button is not button 180 or button 105c, then in step 230, item selection system 100 determines whether the selected button is button 185b. If the selected button is button 185b, then in step 235, item selection system 100 moves cursor 190 down one item in first menu 140 (if possible), and changes second menu 145 based on the new “focus item” in first menu 140. Operation 200 then returns to step 215. Nevertheless, if the selected button is not button 185b, then in step 240, item selection system 100 determines whether the selected button is button 185a. If the selected button is button 185a, then in step 245, item selection system 100 moves cursor 190 up one item in first menu 140 (if possible), and changes second menu 145 based on the new “focus item” in first menu 140. Operation 200 then returns to step 215. However, if the selected button is not button 185a, then operation 200 returns to step 215. Specifically, item selection system 100 recognizes that the selected button is button 185d, and because first menu 140 already is in first menu space 130, selecting button 185d does not affect the display of item selection system 100.

Referring to FIG. 12b, after the user selects button 180 or button 180c in step 220 and item selection system 100 performs step 225, in step 250, item selection system 100 determines whether there is a third menu 195 associated with the current “focus item” in second menu 145. If there is a third menu 195 associated with the current “focus item” in second menu 145, then in step 255, third menu 195 replaces second menu 145 in second menu space 140. It will be understood by those of ordinary skill in the art that item selection system 100 may perform steps 225, 250, and 255 substantially simultaneously, such that third menu 195 replaces second menu 145 in second menu space 135 at substantially the same time that second menu 145 replaces first menu 140 in first menu space 130. However, if in step 250, item selection system 100 determines that there is no third menu 195 associated with the current “focus item” in second menu 145, then in step 260, item selection system 100 removes second menu 145 from second menu space 135, such that second menu space 135 is empty or includes graphic 150.

After item selection system 100 performs step 255 or step 260, in step 265, item selection system 100 determines whether the user selected button 180 or one of buttons 185a-185d. If the user did not select button 180 or one of buttons 185a-185d, operation 200 returns to step 265 until the user selects button 180 or one of buttons 185a-185d. After the user selects button 180 or one of buttons 185a-185d, in step 270, item selection system 100 determines whether the selected button is button 180 or button 185c. If the selected button is button 180 or button 185c, then in step 275, item selection system 100 replaces second menu 145 with third menu 195 in first menu space 130.

However, if the selected button is not button 180 or button 105c, then in step 280, item selection system 100 determines whether the selected button is button 185b. If the selected button is button 185b, then in step 285, item selection system 100 moves cursor 190 down one item in second menu 145 (if possible), and changes third menu 195 based on the new “focus item” in second menu 145. Operation 200 then returns to step 265. Nevertheless, if the selected button is not button 185b, then in step 290, item selection system 100 determines whether the selected button is button 185a. If the selected button is button 185a, then in step 295, item selection system 100 moves cursor 190 up one item in second menu 145 (if possible), and changes third menu 145 based on the new “focus item” in second menu 145. Operation 200 then returns to step 265. However, if the selected button is not button 185a, then in step 300, item selection system 100 replaces second menu 145 with first menu 140 in first menu space 130. In an embodiment, in step 300, item selection system 100 also replaces third menu 195 with second menu 145 in second menu space 135, or if there currently is no third menu 195 in second menu space 135, item selection system 100 projects second menu 145 in second menu space 135. Specifically, item selection system 100 recognizes that the selected button is button 185d, and that the user wishes to return to first menu 140. Operation 200 then returns to step 215.

Referring to FIG. 12c, after the user selects button 180 or button 180c in step 270 and item selection system 100 performs step 275, in step 305, item selection system 100 again determines whether the user selected button 180 or one of buttons 185a-185d. If the user did not select button 180 or one of buttons 185a-185d, operation 200 returns to step 305 until the user selects button 180 or one of buttons 185a-185d. After the user selects button 180 or one of buttons 185a-185d, in step 310, item selection system 100 determines whether the selected button is button 180 or button 185c. If the selected button is button 180 or button 185c, then in step 315, the activity associated with the “focus item” in third menu 195 is activated, and operation 200 is complete. For example, after item selection system 100 performs step 315, the user can watch the selected movie or play the selected game.

However, if the selected button is not button 180 or button 105c, then in step 320, item selection system 100 determines whether the selected button is button 185b. If the selected button is button 185b, then in step 325, item selection system 100 moves cursor 190 down one item in third menu 195 (if possible). Operation 200 then returns to step 305. Nevertheless, if the selected button is not button 185b, then in step 330, item selection system 100 determines whether the selected button is button 185a. If the selected button is button 185a, then in step 335, item selection system 100 moves cursor 190 up one item in third menu 195 (if possible). Operation 200 then returns to step 305. However, if the selected button is not button 185a, then in step 340, item selection system 100 replaces third menu 195 with second menu 145 in first menu space 130. In an embodiment, in step 345, item selection system 100 also projects third menu 195 in second menu space 135. Specifically, item selection system 100 recognizes that the selected button is button 185d, and that the user wishes to return to second menu 145. Operation 200 then returns to step 265.

While the invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein. It is intended that the specification and the described examples are consider exemplary only, with the true scope of the invention indicated by the following claims.

What is claimed is:

1. An item selection system, comprising:
a first menu projected in a first menu space of a viewing surface, wherein the first menu comprises:
a first plurality of items; and
a cursor adapted for movement among the first plurality of items and for selecting a particular item from the first plurality of items; and
a second menu projected in a second menu space of the viewing surface, such that the first menu and the second menu are simultaneously displayed in the viewing surface, wherein the second menu space is positioned adjacent to the first menu space, and the second menu comprises a second plurality of items associated with the particular item, such that when the cursor selects the particular item, at least one portion of the second menu replaces the first menu in the first menu space.

2. The system of claim 1, wherein when the cursor selects the particular item, the entire second menu replaces the first menu, such that the second plurality of items replace the first plurality of items.

3. The system of claim 1, wherein when the cursor selects the particular item, a third menu replaces the second menu in the second menu space.

4. The system of claim 3, wherein the third menu comprises a third plurality of items, and the third plurality of items are associated with one of the second plurality of items.

5. The system of claim 1, further comprising means electrically coupled to the cursor for moving the cursor within the first menu space.

6. The system of claim 5, wherein the means for moving includes at least one button on a controller.

7. The system of claim 5, wherein the means for moving includes a mouse.

8. The system of claim 5, wherein when the cursor moves from a first position corresponding to a position of the particular item to a second position corresponding to a position of a further item from the first plurality of items, a fourth menu replaces the second menu in the second menu space, wherein the fourth menu comprises a fourth plurality of items associated with the further item.

9. The system of claim 1, wherein the second menu space further comprises at least one graphic.

10. The system of claim 9, wherein the at least one graphic is associated with one of the first plurality of items or one of the second plurality of items.

11. The system of claim 1, wherein the viewing surface is a television screen.

12. The system of claim 1, wherein the viewing surface is a computer screen.

13. The system of claim 1, wherein the cursor comprises means for indicating at least one navigation option for a user of the system.

14. The system of claim 13, wherein the means for indicating comprises at least one directional arrow associated with the at least one navigation option.

15. The system of claim 1, further comprising means for replacing the at least one portion of the second menu with the first menu after the cursor selects the particular item.

16. An item selection system, comprising:
a first menu projected in a first menu space of a viewing surface, wherein the first menu comprises:
at least one first item; and
a cursor adapted for movement within the first menu and for selecting a particular item from the at least one first item; and
a second menu projected in a second menu space of the viewing surface, such that the first menu and the second menu are simultaneously displayed in the viewing surface, wherein the second menu space is positioned adjacent to the first menu space, and the second menu comprises at least one second item associated with the particular item, such that when the cursor selects the particular item, at least one portion of the second menu replaces the first menu in the first menu space.

17. The system of claim 16, wherein the at least one first item comprises a plurality of first items, and the at least one second item comprises a plurality of second items.

18. A method for displaying a selection system, comprising the steps of:
projecting a first menu in a first menu space of a viewing surface, wherein the first menu comprises:
a first plurality of items; and
a cursor adapted for movement among the first plurality of items and for selecting a particular item from the first plurality of items; and
simultaneously projecting a second menu in a second menu space of the viewing surface, wherein the second menu space is positioned adjacent to the first menu space, and the second menu comprises a second plurality of items associated with the particular item, such that when the cursor selects the particular item, at least one portion of the second menu replaces the first menu in the first menu space.
